(19) United States
(12) Patent Application Publication
(10) Pub. No.: US 2010/0196622 A1
(43) Pub. Date: Aug. 5, 2010

(54) PORTABLE ULTRAVIOLET AND VISIBLE LIGHT LAMP

(75) Inventors: Maarten Van Pul, Oegstgeest (NL); Huig Klinkenberg, Katwijk (NL)

Correspondence Address: KENYON & KENYON LLP, ONE BROADWAY, NEW YORK, NY, 10004, US

(73) Assignee: Akzo Nobel Coatings International B.V

(21) Appl. No.: 12/679,590

(22) PCT Filed: Sep. 25, 2008
(86) PCT No.: PCT/EP08/62809

§ 371 Date: Mar. 23, 2010

Related U.S. Application Data
(60) Provisional application No. 60/976,605, filed on Oct. 1, 2007.

(51) Int. Cl. B05D 3/06; F21V 29/02

(52) U.S. Cl. 427/558; 315/112

(57) ABSTRACT

The invention relates to a portable ultraviolet/visible light (UVA/IS) lamp having a UVA/IS-light emitting diode (UVA/IS-LED) unit comprising a plurality of UVA/IS-LEDs as UVA/IS radiation source, a UVA/IS-LED electric power supply, and a cooling medium feed line connectable to a cooling medium reservoir for providing a flow of cooling medium to the UVA/IS-LEDs.

The invention relates to a portable ultraviolet and visible light (UV/VIS) lamp having a plurality of UV/VIS light emitting diodes (UV/VIS-LEDs) as UV/VIS radiation source. The invention further relates to a process of preparing a cured coating.

Hand-held portable UV/VIS-LED lamps are commercially available, for example from Panacol-Elosol GmbH in Germany or from Clearstone Technologies Inc. in the United States of America. Movable UV/VIS lamps for curing surface coated materials are described in International Patent Application WO 2006/047866 A. This document describes UV/VIS radiation sources mounted on a positioning panel supported by a stand. Fluorescent lamps, LEDs, electron beams, and lasers are mentioned as suitable radiation sources. In connection with fluorescent lamps, air cooling by a blower, fan or pressurized air is mentioned.

A drawback of the known hand-help UV/VIS-LED lamps is the limited UV/VIS light intensity they generate, as well as the limited area covered by the UV/VIS radiation. UV/VIS-LEDs are characterized by a more efficient conversion of electric energy into UV/VIS radiation than traditional UV/VIS radiation sources, such as fluorescent lamps, or metal halide lamps. However, also in UV/VIS-LEDs a significant proportion of the electric energy is transformed into heat. In addition, the maximum operating temperature of LED is generally lower, about 120° C., than the operating temperature of conventional UV lamps. The durability of UV/VIS-LEDs decreases when they are operated at too high temperature. Therefore, increasing the UV/VIS light intensity and the area covered by UV/VIS generation by using a higher number of individual UV/VIS-LEDs leads to the problem of increased operating temperature of the UV/VIS-LEDs. Therefore, cooling means are required in order to prevent overheating of the UV/VIS-LED lamp. However, cooling means such as blowers or fans generally add to the complexity, weight, and size of a portable UV/VIS-LED device.

The present invention seeks to alleviate the above-mentioned problems. More in particular, the invention seeks to provide a portable UV/VIS-LED lamp capable of generating high intensity UV/VIS radiation and having simple, small and light weight cooling means.

The invention now provides a portable ultraviolet (UV/VIS) lamp having a UV/VIS-light emitting diode (UV/VIS-LED) unit comprising a plurality of UV/VIS-LEDs as UV/VIS radiation source, a UV/VIS-LED electric power supply, and a cooling medium feed line connectable to a cooling medium reservoir for providing a flow of cooling medium to the UV/VIS-LEDs.

The use of UV/VIS-LEDs has several advantages over conventional sources of UV/VIS radiation. UV/VIS-LEDs allow instant on/off switching of the UV/VIS radiation source, which adds flexibility. Furthermore, the service life of UV/VIS-LEDs generally is significantly longer than the service life of conventional UV/VIS sources, for example up to 50,000 hours for a UV/VIS-LED compared to about 1,000 hours for conventional UV/VIS lamps. Further, UV/VIS-LEDs generally have a narrow wavelength distribution and offer the possibility to customize the peak wavelength. The peak wavelength of the UV/VIS-LEDs suitable is between 200 nm and 500 nm. When pure UV light is required, the peak wavelength suitably is between 200 and 400 nm. In order to reduce the health risks associated with skin and eye exposure to UV radiation, it may be preferable to use UV-LEDs having a peak wavelength in the range of 320 to 400 nm. However, it is also possible to use UV/VIS-LEDs having a peak wavelength in the wavelength range of visible light, such as 400 nm to 500 nm. Another advantage of UV/VIS-LEDs is their relatively low working voltage, which is preferred in a paint spray booth environment compared to the higher voltages needed for normal UV/VIS lamps.

The plurality of UV/VIS-LEDs of the lamp can suitably be grouped together in a so-called UV/VIS-LED array. The number of individual UV/VIS-LEDs in a UV/VIS-LED array can be customized depending on the required size, shape, and UV/VIS radiation output required. A UV/VIS-LED array can for example comprise 10 to 50, or several hundreds or even thousands of individual UV/VIS-LEDs.

The shape of the UV/VIS-LED array is not critical. It may be of any suitable shape. As an example, a circular UV/VIS-LED array to be placed around the nozzle of a paint spray gun may be mentioned.

The UV/VIS-LED electric power supply can be a battery pack. In one embodiment, the batteries are rechargeable. It is also possible to use a power supply connected to the electric power grid.

The cooling medium feed line is connected to the UV/VIS lamp so as to provide a flow of cooling medium to the UV/VIS-LEDs. The cooling medium feed line suitably is made of a flexible material, for example rubber or plastic, which may optionally be reinforced with fibers or wires. The cooling medium feed line can be permanently attached to the UV/VIS lamp. Alternatively, the cooling medium feed line can be releasably attached to the UV/VIS lamp, for example by a bayonet-type fitting.

The cooling medium feed line is connectable to a cooling medium reservoir. In operation, the cooling medium feed line is connected to the cooling medium reservoir. Cooling medium will then flow from the reservoir to the UV/VIS-LEDs in order to cool them. The cooling medium can be a liquid cooling medium or it can be a gas, in particular a compressed gas. An example of a suitable liquid cooling medium is water. An example of a gaseous cooling medium is compressed air. Compressed air is particularly suitable as cooling medium when the UV/VIS lamp is used for UV/VIS curing of paint, because compressed air reservoirs are present anyway in many paint spray shops.

When air or a similar non-toxic gas or gas mixture is used a cooling medium, the cooling medium can be discharged directly into the environment without any negative consequences. In a further embodiment, the UV/VIS lamp additionally comprises a cooling medium discharge line for discharge of the cooling medium. Depending on the type of cooling medium used, the cooling medium can be disposed off through the cooling medium discharge line or it can be recycled to the cooling medium reservoir.

The portable UV/VIS lamp suitably is a hand-held device. The UV/VIS lamp can be used as such as hand-held UV/VIS lamp. In another embodiment, the UV/VIS lamp can be part of a paint spray gun, for example such as described in International Patent Application WO2004/069427. The UV/VIS lamp can be permanently attached to the paint spray gun. In another embodiment, the UV/VIS lamp has means for releasably attaching the UV/VIS lamp to a paint spray gun. In this case the UV/VIS lamp can be used as such or attached to a paint spray gun. It is also possible to releasably combine the UV/VIS lamp with a specific holder to allow easy manipulation of the UV/VIS lamp.

In one embodiment, the cooling medium stream path comprises a valve for control of cooling medium flow. The cooling medium stream path includes the cooling medium feed line, the interior of the UV/VIS-LED unit, and the optional cooling medium discharge line. The UV/VIS-LED power supply switch is preferably implemented in such a way that the power supply can only be switched on when the valve in the cooling medium stream path is open. This can for example be achieved by physically coupling the trigger for opening the valve and the button for actuating the electrical switch of the power supply. In a further embodiment, the cooling medium stream path comprises a valve for control of cooling medium flow and a sensor to detect the flow of cooling medium. The UV/VIS-LED power supply can be switched on or off as a function of flow of cooling medium detected by the sensor. It should be noted that the term flow sensor includes embodiments wherein flow is detected by pressure differences sensed by one or more pressure sensors. When the flow in the cooling medium stream path exceeds a predetermined value, the sensor can cause the UV/VIS-LED power supply to be switched on. When the detected flow is below a predetermined value, the sensor can cause the UV/VIS-LED power supply to be switched off. In a simplified embodiment, the predetermined flow value can be 0 l/min. In that case, the device is switched on when the flow of cooling medium exceeds 0 l/min and the device is switched off when there is no flow of cooling medium. The flow of cooling medium is generally actuated by the user, for example by pulling a trigger to open the valve in the cooling medium stream path, for example in the feed line. Upon flow of the cooling medium, the UV/VIS-LED power supply and accordingly the UV/VIS-LEDs will be switched on, and they will be switched off when the flow of cooling medium stops, for example when the trigger is released. In such an embodiment it is assured that UV/VIS-LEDs will only be switched on if there is sufficient flow of cooling medium. Therefore, overheating of the UV/VIS-LEDs can be safely excluded. Portable UV/VIS lamps are frequently used for curing UV/VIS-curable coatings and adhesives. Coating and adhesive materials often contain volatile organic compounds, such as solvents and/or monomers, which evaporate during and/or after application to a substrate. This can lead to an explosive atmosphere in the vicinity of the coated substrate. Therefore, curing with UV/VIS lamps which are not explosion-proof can only be started after an aeration period sufficient to remove the volatile organic compounds. This brings about a delay in the entire process and can have a negative impact on the economy of the coating process. It should be noted that UV/VIS curing processes are frequently very fast. As a consequence, the above-mentioned aeration phase may become the bottleneck for optimizing the process speed for coating and UV/VIS curing. Therefore, there is a need in the coating and adhesive industry for a portable UV/VIS lamp which can safely be used immediately after application of a coating or adhesive layer in an explosive environment.

The portable UV/VIS lamp of the invention can be easily adapted for safe use in an explosive environment. This can be greatly facilitated by spatially separating the UV/VIS-LED power supply and the sensor for detecting the flow of cooling medium from the UV/VIS-LED unit. The sensor to detect the flow of cooling medium and the UV/VIS-LED electric power supply are suitably located in an area with a non-explosive atmosphere. The UV/VIS-LED unit cannot trigger an explosion during normal operation, because all electrical parts which could trigger an ignition or explosion can be located outside the area of explosive atmosphere. Additional measures can be taken to minimize explosion risk in case of likely failures, such as mechanical damage. An example of such an additional measure is creating and automatically monitoring overpressure in the LED chamber. Upon failure of the overpressure, the device is automatically switched off. A mechanical trigger to open the valve in the cooling medium feed or discharge line can be located close to the UV/VIS-LED unit. In such an embodiment, the UV/VIS-LED lamp can be switched on or off by an operator actuating the mechanical trigger in the vicinity of the UV/VIS-LED unit. Pulling the mechanical trigger in the explosive atmosphere opens the valve in the cooling medium feed or discharge line. This starts the flow of cooling medium which is detected by the flow sensor outside the explosive environment. In response to detected flow, the flow sensor causes the UV/VIS-LED power supply, which is also located outside the explosive environment, to be switched on.

The UV/VIS lamp of the invention can be used for all purposes where UV/VIS radiation is required. The UV/VIS lamp is particularly suitable for curing UV/VIS radiation-curable coatings and adhesives. Therefore, the invention also relates to a process of preparing a cured coating comprising applying a UV/VIS-curable coating composition to a substrate and curing the coating by irradiation with UV/VIS-radiation, wherein the UV/VIS radiation is provided by the portable UV/VIS lamp according to the invention. The substrate can for example be an automobile or a large transportation vehicle, such as a train, bus, truck, or aircraft. The process can also be implemented for repair coating of automobiles and transportation vehicles. The process is particularly suitable for repair purposes wherein only a part of the substrate, for example an individual body panel or a damaged spot, is provided with a repair coating.

1. A portable ultraviolet/visible light (UV/VIS) lamp having a UV/VIS-light emitting diode (UV/VIS-LED) unit comprising a plurality of UV/VIS-LEDs as UV/VIS radiation source, a UVN1S-LED electric power supply, and a cooling medium feed line connectable to a cooling medium reservoir for providing a flow of cooling medium to the UV/VIS-LEDs.

2. The portable UV/IS lamp according to claim 1, wherein the UV/VIS lamp additionally comprises a cooling medium discharge line.

3. The portable UV/VIS lamp according to claim 1 , wherein the cooling medium stream path comprises a valve for control of the flow of cooling medium and a sensor to detect the flow of cooling medium, and wherein the UV/VIS-LED power supply can be switched on or off as a function of flow of cooling medium detected by the sensor.

4. The portable UV/VIS lamp according to claim 1, wherein the UV/VIS lamp is a hand-held UV/VIS lamp.

5. The portable UV/VIS lamp according to claim 1, wherein the UV/VIS lamp is part of a paint spray gun.

6. The portable UV/VIS lamp according to claim 1, wherein the UV/VIS lamp has means for removable attachment of the lamp to a paint spray gun or to a holder.

7. The portable UVN1S lamp according to claim 1, wherein the cooling medium feed line is connected to a cooling medium reservoir containing a compressed gas.

8. The portable UV/VIS lamp according to claim 7, wherein the compressed gas is compressed air.

9. The portable UV/VIS lamp according to claim 3, wherein the UV/VIS lamp is adapted for operation in an explosive atmosphere.

10. The portable UV/VIS lamp according to claim 9, wherein the sensor to detect the flow of cooling medium and the UV/VIS-LED electric power supply are spatially separated from the UV/VIS-LED unit.

11. The portable UV/VIS lamp according to claim 10, wherein the sensor to detect the flow of cooling medium and the UV/VIS-LED electric power supply are located in an area with a non-explosive atmosphere.

12. A process of preparing a cured coating comprising applying a UV/VIS-curable coating composition to a substrate and curing the coating by irradiation with UV/VIS-radiation, wherein the UV/VIS radiation is provided by the portable UV/VIS lamp according to claim 1.

13. The process according to claim 12, wherein the substrate is an automobile or a large transportation vehicle.
